(19) United States
(12) Patent Application Publication
(10) Pub. No.: US 2007/0274655 A1
(43) Pub. Date: Nov. 29, 2007

(54) LOW-LOSS OPTICAL DEVICE STRUCTURE

(75) Inventors: Thomas Keyser, Plymouth, MN (US); Grenville Hughes, Wayzata, MN (US); Jerry Yue, Roseville, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/557,185

(22) Filed: Nov. 7, 2006

Related U.S. Application Data
(63) Continuation-in-part of application No. 11/412,738, filed on Apr. 26, 2006.

(51) Int. Cl. G02B 6/10

(52) U.S. Cl. 385/131

(57) ABSTRACT

A method of fabrication and a structure for a low-loss optical device. The optical device structure includes a waveguide that is formed within a device layer of an SOI substrate. A cladding region is formed beneath the waveguide and a BOX layer of the SOI substrate. The cladding region may comprise an air cavity or a cavity that is filled or at least partially filled with a dielectric material. Because the cladding region is formed in the bottom side, it supplements the BOX layer cladding. Consequently, a thinner BOX layer may be used for both electronic and optical devices, which facilitates optoelectronic IC processing and design.

### PRIORITY

The present application claims priority to U.S. patent application Ser. No. 11/412,738, entitled “Optical Coupling Structure,” filed Apr. 27, 2006, which is hereby incorporated by reference herein in its entirety.

### FIELD

The present invention relates generally to optoelectronic integrated circuits and more particularly to a low-loss optical structure and method of fabrication for low-loss optical devices using a silicon-on-insulator (SOI) substrate.

### BACKGROUND

Optoelectronic integrated circuits (ICs) include both electronic and optical elements within a single chip. Typical electronic elements include field effect transistors (FETs), capacitors, and, resistors; typical optical elements include waveguides, optical filters, modulators, and photodetectors. Within a given optoelectronic IC, some of the electronic elements may be dedicated to handling tasks such as data storage and signal processing. Other electronic elements may be dedicated to controlling or modulating the optical elements. Including both types of elements on a single chip provides several advantages, which include reduced layout area, cost, and operational overhead. In addition, such integration yields hybrid devices, such as an opto-isolator.

The integration of optical and electronic elements has been greatly facilitated by the maturation of today's semiconductor processing techniques. For instance, conventional processing techniques may be adapted to create silicon-based prisms, waveguides, and other optical devices.

In general, optoelectronic ICs are fabricated in SOI based substrates. Advantageously, SOI substrates provide a thin device layer located on top of a buried oxide (BOX) layer. Both electronic and optical devices may be formed in or on the device layer. In purely electronic devices, such as FET devices, the BOX layer may serve to electrically isolate the device layer from the bulk layer. In optical devices, the BOX layer may serve as a cladding layer. Generally speaking, in both electronic and optical devices, a thicker BOX layer promotes both electrical isolation in an electronic device and optical confinement in an optical device. Unfortunately, however, thick BOX layers (larger than 2500 Angstroms) also increase the likelihood of wafer bowing prior to or during fabrication. In particular, larger wafers, such as 8 inch or 12 inch wafers, are more susceptible to wafer bowing. In addition, a thick BOX layer also reduces the electronic device capacitance and alters the operating characteristics of the circuit, which necessitates the creation of alternative material-specific device models and circuit cell libraries for integrated opto-electronic product design.

### SUMMARY

Therefore, a low-loss optical device structure is described. In one example, the structure includes an SOI substrate and a cladding region in a bulk layer of the SOI substrate. The SOI substrate includes a device layer that comprises an optical device region. The cladding region is formed adjacent to a BOX layer of the SOI substrate and below the optical device region. In addition, the cladding region has an associated width that is larger than a width associated with the optical device region.

The cladding region may be formed by etching a cavity and/or a trench into the bulk layer. If a cavity is formed, the cavity has a width that is larger than a width of the optical device region. If a trench is formed, the trench has a width that extends beyond the width of the optical device region. The cavity and/or trench may be an air cavity. Alternatively, the cavity and/or trench may be filled or at least partially filled with a dielectric material, such as an oxide, for example.

The cladding region may be formed by depositing a masking layer on the bulk layer, patterning the masking layer to define a region of the cavity and/or trench, and using an etching process to transfer a pattern associated with the cavity and/or trench into the bulk layer. The masking layer, for example, may include a photoresist masking layer and/or a hard masking layer.

In another example, the optical device structure may include a waveguide and/or a prism. The waveguide may be located on a front side of the SOI substrate and the prism may be located on a bottom side of the SOI substrate. The BOX layer may provide an evanescent coupling between the front side and the bottom side of the SOI substrate.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

Certain example embodiments are described below in conjunction with the appended drawing figures, wherein like reference numerals refer to like elements in the various figures, and wherein:

FIG. 1 is a lengthwise cross section of an optical device structure, according to an example;

FIGS. 2A and 2B are lengthwise cross sections showing a light beam being evanescently coupled into and out of a waveguide, according to an example;

FIGS. 3A and 3B are top view diagrams of an SOI substrate that comprises a waveguide on the topside of the substrate and a cladding region on the bottom side of the substrate;

FIG. 4 is a lengthwise cross section of an SOI substrate, according to an example;

FIG. 5A is another lengthwise cross section of an SOI substrate with a cladding region located in the bulk layer, according to an example;

FIG. 5B is a widthwise cross section of the SOI substrate of FIG. 5, according to an example;

FIGS. 6A and 6B are flow diagrams for forming a cladding region in a bulk layer of an SOI substrate;

FIG. 6C is a lengthwise cross section of an SOI substrate having a cavity that has been filled with a dielectric material;

FIG. 7 is a top view diagram of an SOI substrate that comprises a waveguide on the topside of the SOI substrate and a cladding region and an optical device on the bottom side of the SOI substrate; and

FIG. 8 is a lengthwise cross section of an SOI substrate with a cladding region and an optical device located on the bottom side of the SOI substrate, according to an example.

### DETAILED DESCRIPTION

In one form or another, the various embodiments describe a low-loss optical device structure and method of fabrication. The method includes forming a cladding region that is below an optical device and adjacent to a buried oxide region of an SOI substrate. The described cladding region compensates for a thin BOX layer. Thus, the combination of a BOX layer and the cladding region is a structure that serves as the bottom cladding of an optical device, such as a waveguide, for example.

Overall, the optical device structures described below are implemented in a variety of conventional semiconductor processes and combinations thereof, which include: lithography, etching, thin-film deposition, and anti-reflective coatings.

For simplicity, the description below and related figures describe an optical device structure that includes a silicon-based waveguide that comprises a single crystalline silicon layer. In alternative examples, however, the described cladding region may be used to reduce optical losses in a variety of optical devices and is not limited to one particular type of optical device or optical coupling arrangement. For example, the described cladding region may be used to reduce optical losses in devices such as splitters, mirrors, gratings, resonators and modulators.

It should also be understood that the illustrated optical elements described below may comprise various materials and multiple layers with specific characteristics for each individual layer (i.e., doping, thickness, resistivity, etc.). The thickness of a waveguide, for example, may be tailored to accommodate one or more modes of a propagating light beam. In addition, although the described embodiments below use silicon-based optical elements, other types of high index materials (i.e., gallium arsenide, lithium niobate, indium phosphide, etc.) may replace silicon-based elements. Further, unless stated otherwise, the illustrated elements may take on a variety of shapes and sizes.

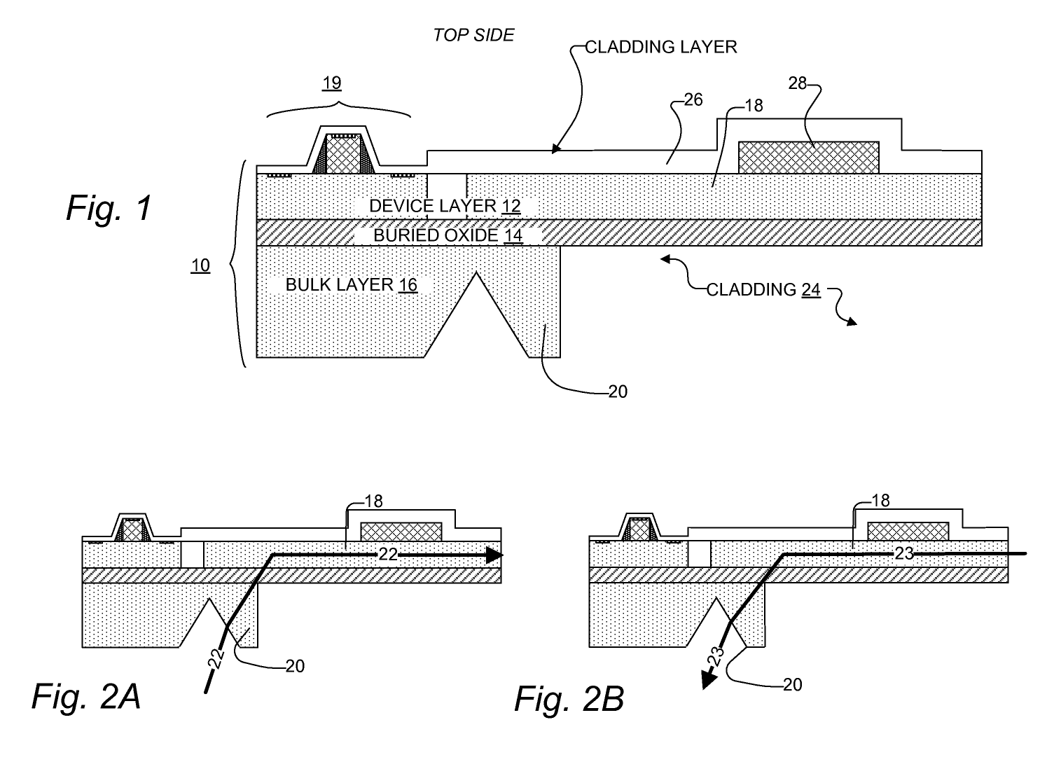

Turning now to the figures, FIG. 1 is a lengthwise cross-section of an optical device structure. The optical device structure is formed in an SOI substrate 10 that includes a device layer 12, a BOX layer 14, and a bulk layer 16. The device layer 12 is located on the top side of the SOI substrate 10 and the bulk layer 16 is located on the bottom side of the SOI substrate 10. The BOX layer 14 is located substantially between the device layer 12 and the bulk layer 16. The device layer 12 includes a waveguide 18, which may be tailored to a variety of thickness in order to achieve desired optical characteristics of the waveguide (e.g., mode selection).

The BOX layer 14 may serve a variety of purposes. For example, The BOX layer 14 provides electrical isolation to microelectronic devices, such as a FET 19. The BOX layer 14 also promotes optical confinement within the waveguide 18.

In addition, the BOX layer 14 may also serve as an evanescent coupling between a top side and a bottom side of the SOI substrate 10. For example, to introduce a light beam into the waveguide 18 or draw light out of the waveguide 18, the BOX layer 14 serves as a spacer. As a spacer, the BOX layer 14 accurately sets a distance between a prism 20 and the waveguide 18 and as a result, enables efficient and repeatable coupling of light into and out of the waveguide 18.

FIGS. 2A and 2B show at least two operating scenarios of the optical coupling structure of FIG. 1. To bring light into the waveguide 18, FIG. 2A shows a light beam 22 that enters the prism 20 and refracts. BOX layer 14 assists in coupling beam 22 to the waveguide 18. To bring light out of the waveguide 18, FIG. 2B shows a light beam 23 that transfers out of the waveguide 23 through the BOX layer 14 to the prism 20. It should be noted that at least a portion of the waveguide 18 and the prism 20 may be used to couple light into and out of the waveguide 18. The evanescent coupling of light via a BOX layer is further described in commonly-assigned U.S. patent application Ser. No. 11/412,738, Keyser et al., the disclosure of which is herein incorporated by reference.

To act as a spacer and also to prevent wafer bowing during fabrication, the BOX layer 14 should be less than about 2500 Angstroms or less in thickness. However, to clad the waveguide 18 and thus efficiently guide the light beam, the waveguide 18 should be surrounded by cladding layers that have a low index and sufficient thickness. To clad the top of the waveguide 18, an oxide layer 26 is grown or thermally deposited above the waveguide 18. In one example, the thickness of the oxide layer 26 should be about 1 um or more.

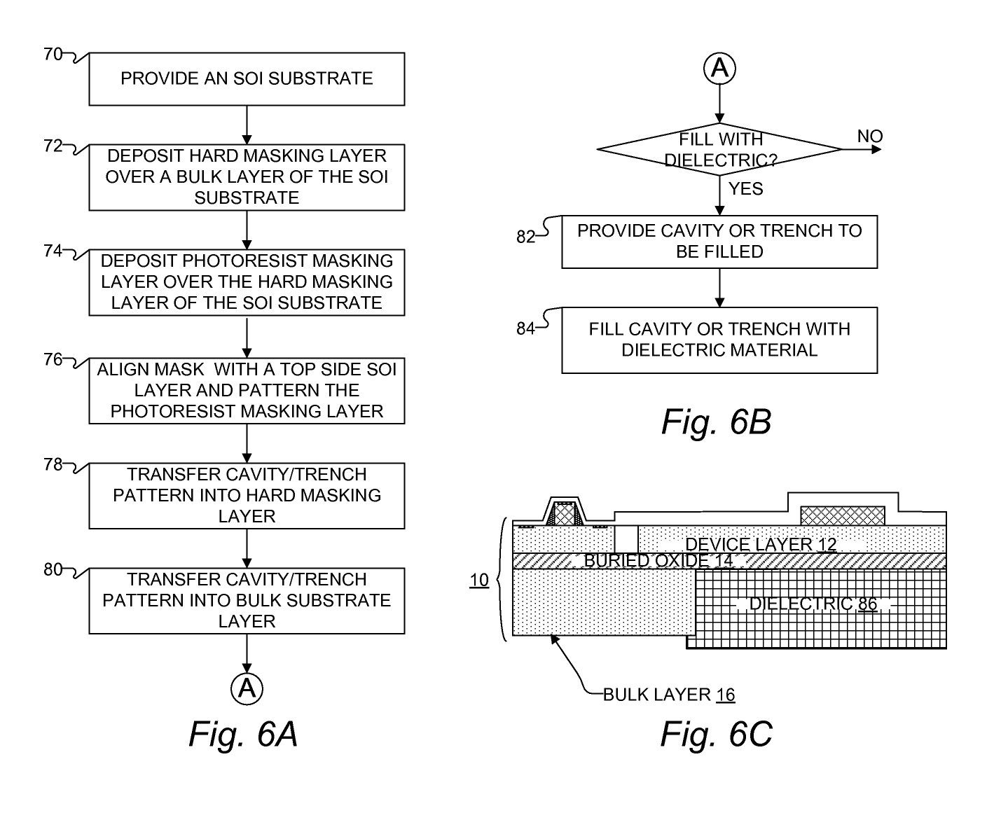

However, to clad the bottom of the waveguide 18, a BOX layer 14 may not be sufficient in adequately confining a light beam within the waveguide 18. Therefore, a cladding region 24 is formed below the waveguide 18. In general, the cladding region 24 serves to increase the cladding thickness of the BOX layer 14. Preferably the cladding region 24 is an air cavity, which inherently has a low index of refraction. However, the cladding region 24 may also be filled with a dielectric material such as an oxide, nitride, polymer film, or combination thereof. More detail with respect to filling the cladding region will be described with reference to FIG. 6B

FIG. 1 also shows an optical device 28 located within a vicinity of the waveguide 18. It should be noted that a variety of other microelectronic, micro electromechanical, and/or optical elements may exist within, above, or below the SOI substrate 10. For example, the optical device 28 may comprise a modulator, which adjusts the optical characteristics of the waveguide 18.

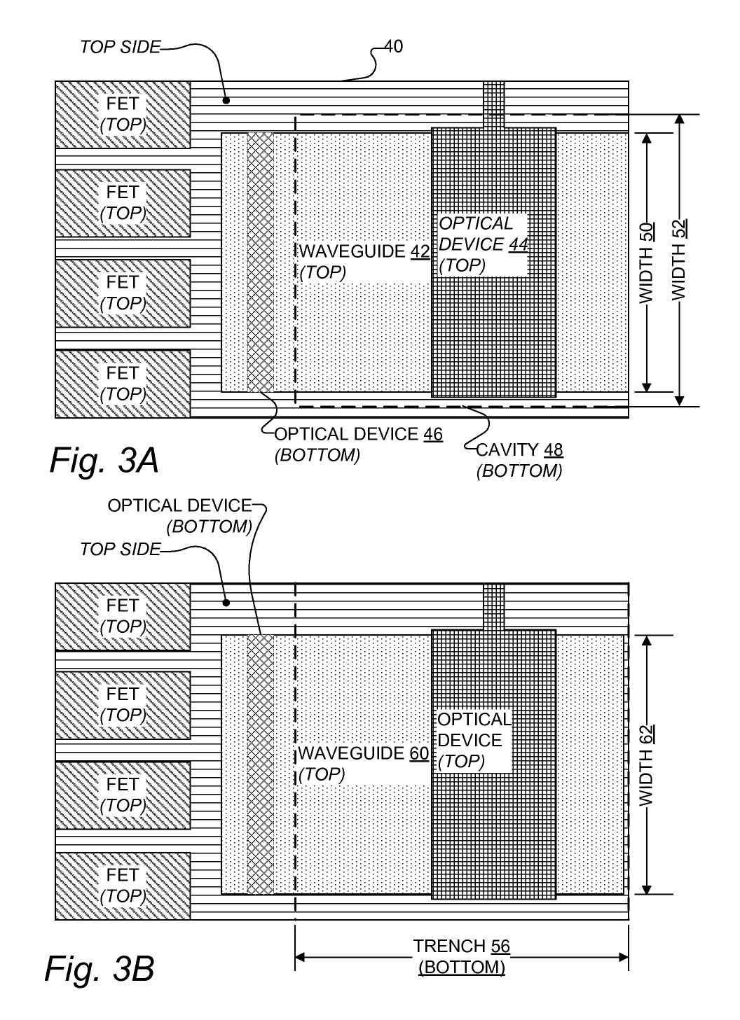

FIG. 3A shows a top view diagram of an SOI substrate 40. The substrate 40 includes a waveguide 42 formed in a device layer and an optical device 44 formed on top of the device layer, which may be a modulator, for example. The substrate 40 may also include electronic devices, which are generally shown as FETs. Underneath the substrate 40, an optical device 46 and a cavity 48 may be formed in a bulk layer of the SOI substrate 40. The optical device 46 may be, for example, a prism, or a grating, that may be used to bring light into or out of the waveguide 42 (i.e., via a BOX layer).

To prevent losses within the waveguide 42, the cavity 48 serves as a cladding region. Preferably the cavity 48 is an air cavity or is a cavity that is filled or at least partially filled with a dielectric material. The dielectric material should have continuous refractive index that is less than the refractive index of the waveguide 42 and less than or equal to the refractive index of a BOX layer. In addition, to promote optical confinement, it is preferable that the cavity 48 has a width 50 that is greater than a width 52 of the waveguide 42. The cavity 48, for example, may be patterned and etched so that the cavity 48 sufficiently overlaps the waveguide 42 and a portion of the substrate 40.

Alternatively, a groove or a trench may be formed in lieu of a cavity. FIG. 3B shows a trench 56 that has been formed on the bottom side of an SOI substrate 58, in a bulk layer, for example. The trench 56 extends beyond a width 58 of a waveguide 60. The trench 56 may also run beneath other optical devices, and thus supply cladding to those device as well.

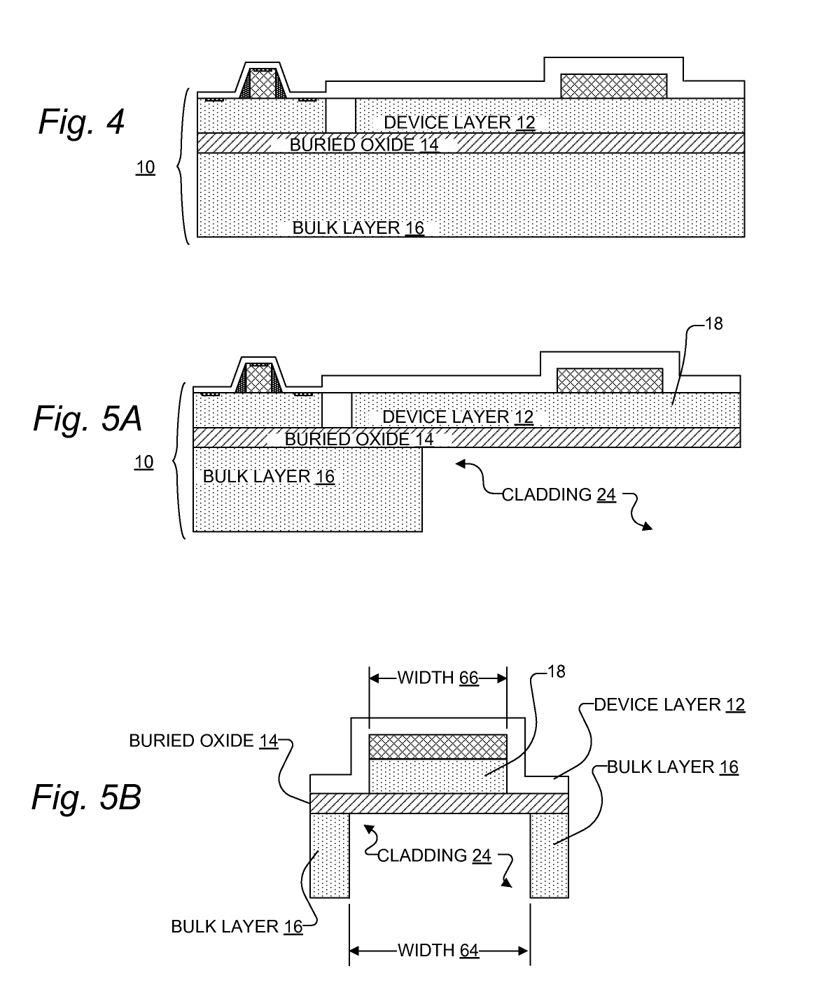

FIG. 4 shows a lengthwise cross-section of the SOI substrate 10 (see FIG. 1) before the cladding region 24 is formed. The cladding region may be formed at any point of a semiconductor fabrication process, such as before or after microelectronic devices are created in the SOI substrate 10. In addition, the cladding region 24 may be formed before or after any optoelectronic devices are created in the SOI substrate 10. Preferably, however, if the cladding region 24 comprises an air cavity (i.e., the cladding region is not filled with a dielectric material), the cladding region is formed after microelectronic and optoelectronic devices are formed. For example, grooves or trenches in the bottom side of wafer may make it difficult to accommodate such a wafer in various types of semiconductor tooling.

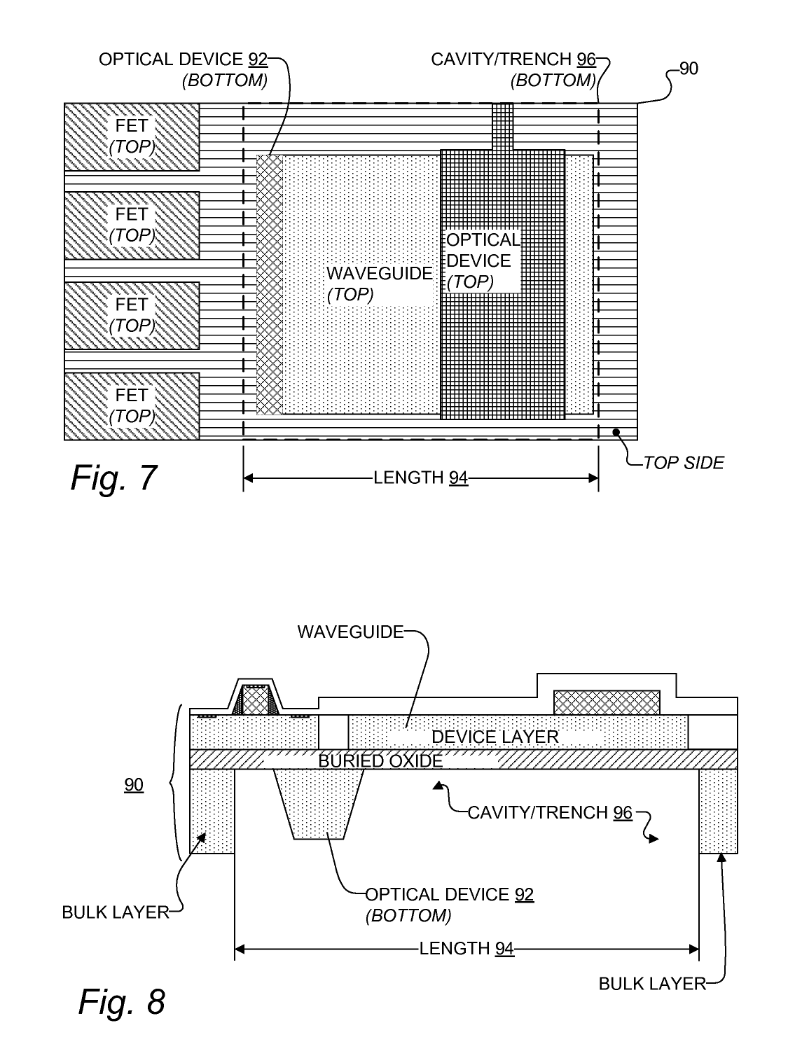

FIG. 5A shows a lengthwise cross-section of the SOI substrate 10 after the cladding region 24 has been formed. It should also be noted that a prism or other type of optical coupling device may be formed in the bulk layer 16. (see, e.g., FIG. 1). If a prism is formed, it should be noted that the cladding region 24 may be formed before or after the prism is formed. In addition, a prism or other type of optical device may be mounted to the bottom side of an SOI substrate. In such an example, a cladding region may be sized to accommodate the device (described further with reference to FIGS. 7-8)

FIG. 5B shows a widthwise cross-section of the SOI substrate 10 after the cladding region 24 has been formed. Note that a width 64 of the cladding region 24 is larger than a width 66 of the waveguide 18.

Generally speaking, the cladding region 24 may be created in a variety of ways, preferably by a lithography process in combination with an etching step (i.e., a wet or dry etch). FIG. 6A is a flow diagram that shows an example process flow for forming a cladding region within a bulk layer of an SOI substrate. The process flow in FIG. 6A may be may be applied during front-end processing (i.e., before metal is present on a wafer), during back-end processing, or after back-end processing has been completed.

At block 70, an SOI substrate is provided. At block 72, a hard masking layer is deposited on the bulk layer of the bottom side of the SOI substrate. The hard masking layer, for example, may be silicon nitride. At block 74 a photoresist masking layer is deposited over the hard masking layer. At block 76, a mask is aligned to a front side of the SOI substrate and the mask is used to pattern the photoresist masking layer. As described above, a cladding region should be aligned underneath the optical device that is to be cladded. In addition, the cladding region should be aligned so that the cladding region is wider than the device that is to be cladded. For example, the cladding region should be designed to be wider than an optical device region, where the optical device region represents an area where an optical device is or will be located.

To align the cladding region, a mask aligner (e.g. a stepper) may use a camera, for example, to align a mask to features on the top side of the SOI substrate. The cladding region may be aligned with the device itself or various other features on the front side of the SOI substrate. Other methods of alignment, besides a camera, include using an IR source to detect and align front side features with a bottom side mask. In such examples, alignment marks, which can be recognized by the mask aligner, may be patterned into an appropriate layer of the device to enable registration of a backside pattern to a front side (or vice versa).

At block 78, the cavity and/or trench pattern is transferred into the hard masking layer via a wet or dry chemical etch, for example. At block 80, a wet or dry chemical etch process may be used to transfer the cavity and/or trench pattern into the bulk layer. The cavity and/or trench may be etched until the BOX layer is exposed. Alternatively, the etch process may be tailored so that a thin portion of silicon remains between the BOX layer and the cavity and/or trench. This remaining silicon may be subsequently oxidized and thus fill the cavity and/or trench with a thermal oxide (described further with reference to FIG. 6B).

Because the bulk layer may be substantially thick (i.e., on the order of a hundreds of μm), the hard mask may ensure that the photoresist masking layer does not break down during the pattern transfer into the bulk layer. Thus, the etching processes shown at blocks 78, 80 may be one continuous etch step, or a two-step etch process. It should also be understood that the hardmasking layer may not be necessary. For example, the photoresist may be durable enough to remain intact during pattern transfer into the bulk layer.

The photoresist masking layer may be removed during or after the etch process at block 78, or after the etch process at block 80. The photoresist masking layer may be removed by a plasma ash and/or a wet clean, for example. The hard mask layer may be removed by a chemical HF (hydrofluoric acid) or hot phosphoric etch. The type of hard mask strip may depend on the type of hard mask layer that is used.

As described above, a cladding region may be filled or partially filled with a dielectric material. The dielectric material may be used to tailor the index of refraction of the cladding region to a particular optical device or application. FIG. 6B is a flow diagram that shows an example process flow for filling a cavity or trench with a dielectric material.

At block 82, a cavity or trench to be filled is provided. At block 84, the cavity and/or trench is filled with a dielectric material. For example, a chemical vapor deposition (CVD) or a plasma enhanced CVD (PECVD) process may be used to deposit an oxide layer and completely fill or at least partially fill the cavity and/or trench.

It should also be understood that a thermal diffusion process may also be used to grow a dielectric layer within the cavity and/or trench. The dielectric layer may be grown to a preferred thickness that completely fills or at least partially fills the cavity and/or trench. Also, as described above, the cavity and/or trench may include a remaining amount of silicon. This silicon may be oxidized during a wet or dry oxidation, for example. It may be preferable, in some examples, to perform high temperature dielectric deposition steps prior to the formation of microelectronic devices as such temperatures may affect the diffusion profiles of these devices.

FIG. 6C is shows the cavity 24 of FIG. 5B filled with a dielectric material 86. It should be understood that the dielectric material may be further treated in a variety of ways. For example, the dielectric material 86 may be planarized via a chemical mechanical polish or other type of polishing operation.

As mentioned above, a variety of optical devices may be mounted to the bottom side of an SOI substrate. Thus, a cavity and/or trench may be tailored to accommodate such a mounting. FIG. 7 shows a top view of an SOI substrate 90. An optical device 92 is mounted to the bottom side of the SOI substrate 90. Accordingly, a length 94 of a cavity/trench 96 is designed so that optical device may be mounted to a BOX layer of the SOI substrate. FIG. 8 shows a lengthwise cross-section of the SOI substrate 90 and the optical device 92.

Generally speaking, the cladding region allows thinner BOX layers to be used in optoelectronic IC processing and design layout. For example, BOX layers having a thickness that is less than 2500 Angstroms may be used for electrical isolation. Nevertheless, the cladding region insures that optoelectronic devices are adequately cladded.

It should be understood, however, that the illustrated examples and related description are examples only and should not be taken as limiting the scope of the present invention. The methods and structures described above are not limited to a particular type of optical device. Other optical devices may be cladded via the method described above. Moreover, although the disclosure uses a silicon based substrates, a variety of other semiconductor substrates and films may be used instead of silicon and silicon dioxide, such as GaAs, GaN, or InP, for example. In addition, the indexes of any of the above films may be tailored. For example, a cavity may be filled with a dielectric material that has a preferred index of refraction. The claims should not be read as limited to the described order or elements unless stated to that effect. Therefore, all embodiments that come within the scope and spirit of the following claims and equivalents thereto are claimed as the invention.

We claim:

1. A low-loss optical device structure, comprising:
a silicon-on-insulator substrate that includes a device layer and a bulk layer, wherein a buried oxide layer is interposed between the device layer and the bulk layer, and wherein the device layer includes an optical device region; and
a cladding region in the bulk layer, wherein the cladding region is adjacent to the buried oxide layer and positioned below the optical device region, and wherein the cladding region has an associated width that is larger than a width associated with the optical device region.

2. The optical device structure as in claim 1, wherein the cladding region is formed by a process comprising etching a cavity into the bulk layer, wherein the cavity is adjacent to the buried oxide layer and positioned below the optical device region, and wherein the cavity has a width that is larger than the width associated with the optical device region.

3. The optical device structure as in claim 2, wherein the process further comprises filling the cavity with a dielectric material.

4. The optical device structure as in claim 2, wherein the process further comprises growing a dielectric layer in the cavity.

5. The optical device structure as in claim 1, wherein the cladding region is formed by a process comprising etching a trench in the bulk layer, wherein the trench is adjacent to the buried oxide layer and positioned below the optical device region, and wherein the trench has a width that extends beyond the width associated with the optical device region.

6. A method for making a low-loss optical device structure, the method comprising:
providing a silicon-on-insulator substrate that includes a device layer and a bulk layer, wherein a buried oxide layer is interposed between the device layer and the bulk layer, and wherein the device layer includes a waveguide region; and
forming a cladding region in the bulk layer, wherein the cladding region is adjacent to the buried oxide layer and positioned below the waveguide region.

7. The method as in claim 6, wherein the cladding region has an associated width that is larger than a width associated with a waveguide that is to be formed at the waveguide region.

8. The method as in claim 6, further comprising forming a waveguide at the waveguide region, wherein the cladding region has an associated with that is larger than a width associated with the waveguide.

9. The method as in claim 6, wherein forming the cladding region comprises etching a cavity in the bulk layer, wherein the cavity is adjacent to the buried oxide layer and positioned below the waveguide region.

10. The method as in claim 9, wherein etching the cavity in bulk layer comprises:
depositing a masking layer on the bulk layer;
patterning the masking layer to define a location of the cavity; and
using an etch process to transfer a pattern associated with the cavity into the bulk layer.

11. The method as in claim 10, wherein the masking layer comprises at least one of a photoresist masking layer and a hard masking layer.

12. The method as in claim 9, wherein forming the cladding region further comprises depositing a dielectric material in the cavity.

13. The method as in claim 9, wherein forming the cladding region further comprises growing a dielectric layer in the cavity.

14. A low-loss optical device structure, comprising:
a silicon-on-insulator substrate comprising a device layer and a bulk layer, wherein a buried oxide layer is interposed between the device layer and the bulk layer;
an optical device formed in the device layer, wherein the optical device has an associated width; and
a cladding region formed in the bulk layer and adjacent to the buried oxide layer, wherein the cladding region has an associated width that is larger than the width of the optical device.

15. The optical device structure as in claim 14, wherein a portion of the buried oxide layer promotes an optical coupling between a bottom side and a front side of the silicon-on-insulator substrate.

16. The optical device structure as in claim 14, wherein the cladding region comprises a dielectric material.

17. The optical device structure as in claim 14, wherein the cladding region comprises an air cavity formed in the bulk layer, wherein the air cavity is adjacent to the buried oxide layer and positioned below the optical device, and wherein the air cavity has an associated width that is larger than the width of the optical device.

18. The optical device structure as in claim 17, further comprising a prism coupled to the buried oxide layer, wherein the prism is positioned within the air cavity.

19. The optical device structure as in claim 14, wherein the optical device comprises a waveguide.

20. The optical device structure as in claim 19, further comprising a prism that has been formed in the bulk layer, wherein the prism is adjacent to the cladding layer.
